(19) United States
(12) Patent Application Publication
(10) Pub. No.: US 2005/0249357 A1
(43) Pub. Date: Nov. 10, 2005

(54) Multiple function overhead entertainment system for use in a vehicle

(75) Inventor: George C. Schedivy, Aquebogue, NY (US)

Correspondence Address: F. CHAU & ASSOCIATES, LLC, 130 WOODBURY ROAD, WOODBURY, NY, 11797, US

(73) Assignee: Audiovox Corporation

(21) Appl. No.: 10/842,100

(22) Filed: May 10, 2004

(51) Int. Cl. H04B 1/00; H04B 5/00

(52) U.S. Cl. 381/86; 381/79

(57) ABSTRACT

An overhead entertainment system for a vehicle comprises a plurality of media sources outputting at least one of audio data and video data, and means for modulating the audio data and transferring the modulated audio data to a vehicle sound system, wherein the modulated audio data is capable of being transferred to the vehicle sound system via wired and wireless transmission. The overhead entertainment system also comprises means for wirelessly transmitting the video data to at least one display.

### BACKGROUND OF THE INVENTION

1. Technical Field

The present disclosure relates to a multiple function overhead entertainment system for use in a vehicle, and more particularly to an overhead entertainment system capable of operating with a variety of media sources and different means for audio and video output.

2. Discussion of the Related Art

Overhead entertainment consoles mounted in vehicles provide video and audio entertainment to passengers therein. Some known designs of overhead consoles include a screen for displaying video and a media source, such as a video cassette player (VCP) or a digital video disc (DVD) player.

Known overhead consoles are limited with respect to the number and type of media sources that can be operated with the overhead console. Further, known overhead consoles are limited with respect to the number and type of audio and video delivery mechanisms that can be used with the overhead console.

Accordingly, a need exists for an overhead console that can operate with multiple media sources and is capable of outputting audio and video through a variety of output means.

### SUMMARY OF THE INVENTION

An overhead entertainment system for a vehicle, according to an embodiment of the present invention, comprises a media player, a first modulator capable of receiving audio signals for modulation from the media player, wherein the first modulator is connectable to a vehicle sound system via a physical connection for sending modulated audio signals to the vehicle sound system, and a second modulator capable of receiving the audio signals for modulation from the media player, wherein the second modulator includes a transmitter for wirelessly transmitting the modulated audio signals to a receiver coupled to the vehicle sound system.

The media player may be one of an MPEG player, a card reader, a DVD player, a CD-ROM player, a video game player, a videocassette player, and a digital video recorder. The first modulator and the second modulator may be capable of receiving audio signals for modulation from a media source connected to the entertainment system via at least one port. The at least one port may be one of a universal serial bus port, an audio input port, a video input port and an audio/video input port.

The entertainment system may be capable of receiving and playing at least one of a digital video disc, a compact disc, a video compact disc, a flash card, a secure digital card, a smart media card and a memory stick card.

The entertainment system may further comprise a switch for switching a path of the audio signals from the media player to the first modulator or to the second modulator. The entertainment system may also comprise a switch for opening and closing a connection between the first modulator and the vehicle sound system. At installation of the entertainment system into a vehicle, a user may determine whether the audio signals from the media player are received by the first modulator or the second modulator and/or whether to connect the first modulator to the vehicle sound system via the physical connection. The physical connection may include at least one wire.

The transmitter can wirelessly transmit the modulated audio signals to wireless headphones. Wireless transmission of the modulated audio signals, whether to the vehicle sound system or to wireless headphones may be performed on a frequency selected by a user.

The overhead entertainment system may further comprise a transmitter for wirelessly transmitting video data from the media player to at least one display.

Another overhead entertainment system for a vehicle, in accordance with an embodiment of the present invention, comprises a media player, and a modulator capable of receiving audio signals for modulation from the media player, wherein the modulator is connectable to a vehicle sound system via a physical connection for sending modulated audio signals to the vehicle sound system and connectable to a transmitter for wirelessly transmitting the modulated audio signals to a receiver coupled to the vehicle sound system.

The overhead entertainment system may further comprise a switch for opening and closing a connection between the modulator and the transmitter and/or between the modulator and the vehicle sound system. A user may determine, at the time of installation of the entertainment system into a vehicle, whether to connect the modulator to the transmitter and/or whether to connect the modulator to the vehicle sound system via the physical connection. The overhead entertainment system may further comprise a transmitter for wirelessly transmitting video data from the media player to at least one display.

Another overhead entertainment system for a vehicle, in accordance with an embodiment of the present invention, comprises a plurality of media sources outputting at least one of audio data and video data, and means for modulating the audio data and transferring the modulated audio data to a vehicle sound system, wherein the modulated audio data is capable of being transferred to the vehicle sound system via wired and wireless transmission.

The plurality of media sources may include any combination of two or more of the following: an MPEG player, a card reader, a DVD player, a CD-ROM player, a video game player, a videocassette player, and a digital video recorder. At least one of the plurality of media sources may be connected to the entertainment system via at least one port, wherein the at least one port may be a universal serial bus port, an audio input port, a video input port or an audio/video input port.

The means for modulating and transferring may include a modulator for coupling to the vehicle sound system for wired transmission of the modulated audio data to the vehicle sound system and for coupling to a transmitter for wireless transmission of the modulated audio data to the vehicle sound system.

The means for modulating and transferring may include a first modulator for coupling to the vehicle sound system for wired transmission of the modulated audio data to the vehicle sound system, and a second modulator including a transmitter for wireless transmission of the modulated audio data to the vehicle sound system.

The overhead entertainment system may further comprise means for selecting whether the modulated audio data is transferred to the vehicle sound system via wired or wireless transmission and means for wirelessly transmitting the video data to at least one display.

Another overhead entertainment system for a vehicle, in accordance with an embodiment of the present invention, comprises at least one display, at least one media source, and at least one transmitter for wirelessly transmitting video data from the at least one media source to the at least one display.

The overhead entertainment system may further comprise at least one other display, and a physical connection from the overhead entertainment system to the at least one other displays for transmitting the video data from the at least one media source to the at least one other display. The at least one display may be positioned remote from the overhead entertainment system.

The overhead entertainment system may further comprise at least one other media source, wherein the at least one transmitter simultaneously transmits video data from the at least one other media source and the video data from the at least one media source to the at least one display.

The overhead entertainment system may further comprise at least one other media source, and at least one other display, wherein the at least one transmitter simultaneously transmits video data from the at least one other media source to the at least one other display and the video data from the at least one media source to the at least one display. The at least one transmitter may simultaneously transmit video data from both the at least one media source and the at least one other media source to both the at least one display and the at least one other display.

### BRIEF DESCRIPTION OF THE DRAWINGS

Preferred embodiments of the invention can be understood in more detail from the following descriptions taken in conjunction with the accompanying drawings in which:

FIG. 1 shows a perspective view of an overhead entertainment unit, according to an embodiment of the present invention;

FIG. 2A is a block diagram illustrating an overhead entertainment unit including a modulator and a transmitter, according to an embodiment of the present invention;

FIG. 2B is a block diagram illustrating an overhead entertainment unit including two modulators, according to an embodiment of the present invention;

FIG. 3A is a block diagram illustrating a wired connection between the overhead entertainment unit of FIG. 2B and a vehicle sound system, according to an embodiment of the present invention;

FIG. 3B is a block diagram illustrating a wireless connection between the overhead entertainment unit of FIG. 2B and a vehicle sound system and wireless headphones, according to an embodiment of the present invention;

FIG. 3C is a block diagram illustrating switching between the wired and wireless connections shown in FIGS. 3A and 3B, according to an embodiment of the present invention;

FIG. 4A is a block diagram illustrating an overhead entertainment unit including a video transmitter, according to an embodiment of the present invention; and

FIG. 4B shows a perspective view of an overhead entertainment unit, according to an embodiment of the present invention.

### DETAILED DESCRIPTION OF THE PREFERRED EMBODIMENTS

Preferred embodiments of the present invention will be described below in more detail with reference to the accompanying drawings. This invention may, however, be embodied in different forms and should not be construed as limited to the embodiments set forth herein. Rather, these embodiments are provided so that this disclosure will be thorough and complete, and will fully convey the scope of the invention to those skilled in the art.

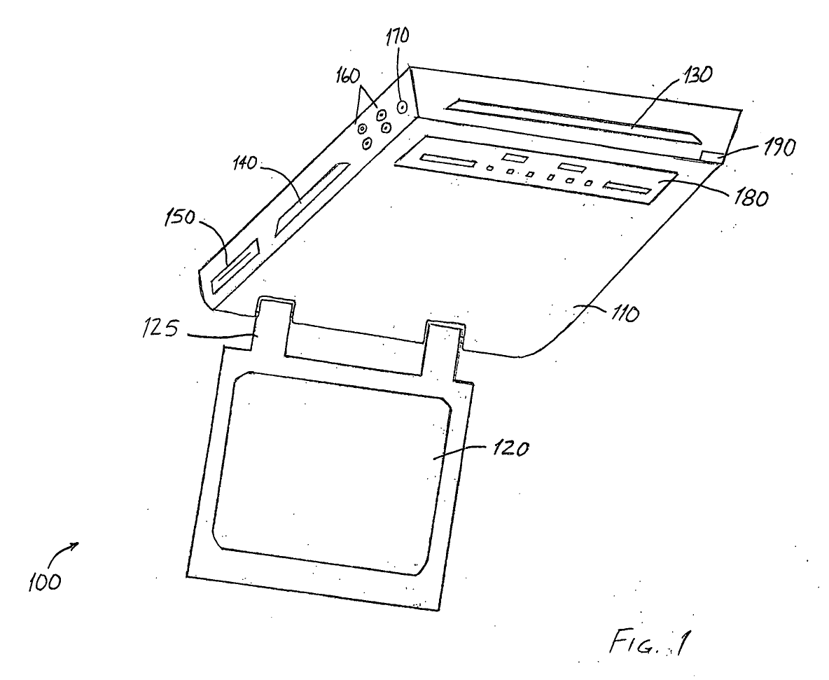

Referring to FIG. 1, an overhead entertainment unit 100 includes a display 120, which is preferably a liquid crystal display (LCD). Alternatively, the display 120 can be a cathode ray tube (CRT), gas plasma or organic electro-luminescent display (OELD) device. The display 120 is preferably supported from the entertainment unit 100 by a hinged mechanism 125 and swings to different viewing angles or folds flat against a body portion 110 of the entertainment unit 100 when not in use.

The entertainment unit 100 includes slots 130 and 140 of different sizes for receiving DVDs, compact discs (CDs), video CDs (VCDs), flash cards, secure digital (SD) cards, smart media (SM) cards and memory stick (MS) cards. Accordingly, the entertainment unit 100 includes media players, such as card readers and DVD and CD players, capable of reading various types of media storage mediums. The entertainment unit 100 can transfer audio data to an audio output, such as headphones or a vehicle sound system and transfer video data to a video output, such as the display 120. As an alternative to using slots, media storage mediums can also be inserted into the docking station using a clamshell type design, whereby a door of the entertainment unit 100 is opened to allow insertion of a media storage medium therein. In addition, a drawer type design may also be implemented whereby a holder for a media storage medium slides out of the entertainment unit 100 (like a drawer) to permit insertion of a media storage device in the holder.

The entertainment unit 100 also includes ports for connecting to external media devices, such as a universal serial bus (USB) port 150 and input/output ports 160. The ports 150 and 160 are used to connect devices, such as an MPEG player, a card reader, a DVD player, a CD-ROM player, a video game player, a videocassette player, and a digital video recorder. For example, audio input ports include XLR and RCA jacks and video input ports include S-video connections, RCA connections, F-connections, and component video. The entertainment unit 100 includes a headphone port 170 for sending audio to headphones. A power port may be included among the input/output ports 160 for connecting to a vehicle power supply through an adapter, such as cigarette lighter adapter. The entertainment unit 100 preferably receives power through a vehicle's wiring harness.

The slots 130 and 140 and the ports 150, 160 and 170 may be positioned in any appropriate location on the entertainment unit 100 and are not restricted to the locations shown in FIG. 1. Similarly, the number of slots and ports may be more or less than that shown in FIG. 1.

The entertainment unit 100 includes a control panel 180 with a variety of control buttons for controlling, for example, power, mode (e.g., DVD, AUX), screen characteristics, and functions of a media source, such as stop, pause, previous, play and next. The control buttons enable a user to control display characteristics and which programs from which sources are displayed. Additional control buttons can include volume control and channel selection. A channel selection button is used to select a frequency, such as 88.1 MHz, for broadcast of audio if audio is being broadcast wirelessly to headphones or to the vehicle's sound system.

The entertainment unit 100 also includes an infra-red (IR) sensor 190 for receiving signals for control of the entertainment unit 100 from a remote control device.

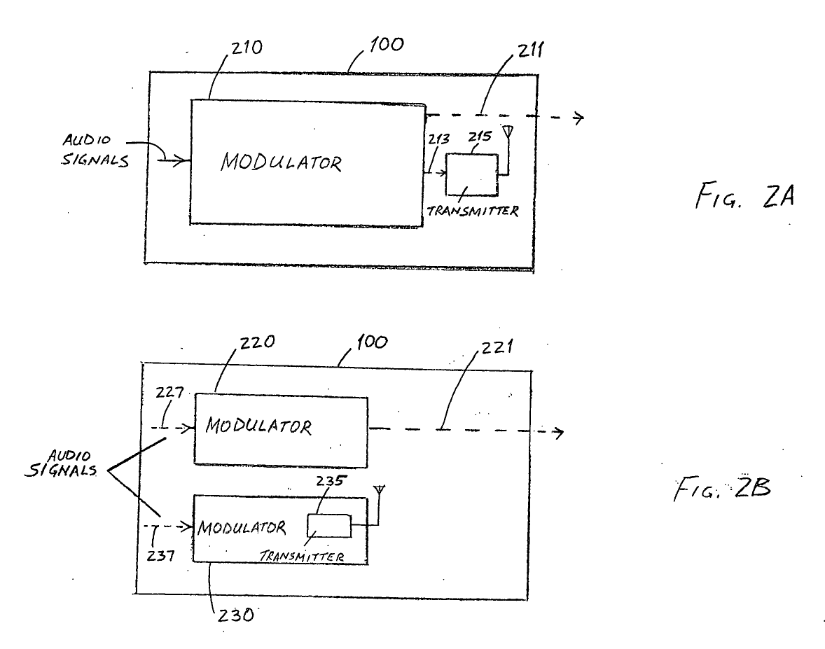

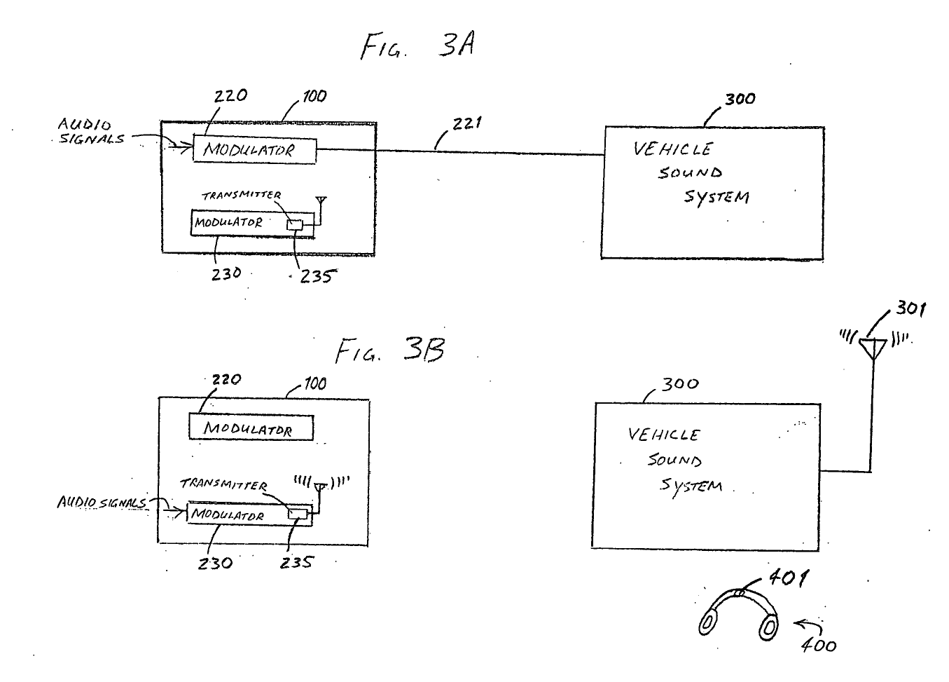

Referring to FIGS. 2A-2B, the entertainment unit 100 either includes a frequency modulator 210 connectable to a transmitter 215 or two frequency modulators 220 and 230. The modulators 210, 220 and 230 modulate audio signals received from a media source in or connected to the entertainment unit 100 for transmission on a selected frequency to a vehicle sound system, such as a radio, or to wireless headphones. Once a modulated signal is received by the radio or wireless headphones, which are tuned to the chosen frequency, the audio signals are then demodulated and are respectively output to speakers in the vehicle or wireless headphones.

Upon installation of the entertainment unit 100 shown in FIG. 2A into a vehicle, a user may opt to connect the modulator 210 directly to a vehicle sound system via a wired connection as shown by arrow 211. The wired connection permits the modulated audio signal to travel via a wire or wires to the vehicle sound system. Alternatively, as shown by arrow 213, the user may opt to connect the modulator 210 to the transmitter 215 instead of wiring the modulator 210 to the vehicle sound system. The transmitter 215 wirelessly transmits a modulated signal to a vehicle antenna and, in turn to the vehicle sound system connected to the vehicle antenna. The transmitter 215 is also capable of transmitting a modulated signal to a receiver in wireless headphones.

The connection to the transmitter 215 may be determined at installation or may be controlled by a selector switch on the control panel 180. If controlled by a selector switch, a user may use the transmitter 215 with wireless headphones regardless of whether the modulator 210 is wired to the vehicle sound system. For example, if the vehicle sound system is turned off and the connection to the transmitter 215 is switched on, the transmitter 215 may be used to transmit modulated audio signals to a receiver in wireless headphones or some other audio output device not connected to the vehicle. Also, in an alternative embodiment, the direct connection between the modulator 210 and the vehicle system may be opened and closed by a selector switch positioned on the control panel 180. Therefore, the inclusion of switches for connecting and disconnecting the modulator 210 to and from the vehicle sound system and the transmitter 215 gives a user the option to choose between wireless and wired transmission after installation of the overhead entertainment unit 100.

The wireless transmission frequency can be selected using a channel selection button on the control panel 180. The frequency can be in the FM band, ranging from about 88 MHz to about 108 MHz or in a digital audio broadcast (DAB) band, including frequencies in and beyond the FM band, ranging from about 88 MHz to about 225 MHz. Frequency may be tunable to a number of frequencies in the ranges in increments of 0.1 MHz.

Upon installation of the entertainment unit 100 shown in FIG. 2B into a vehicle, a user may opt to connect the modulator 220 directly to a vehicle sound system via a wired connection as shown by arrow 221 and, as shown by arrow 227, to create a connection to the modulator 220 for receipt of audio signals to be modulated from a media source in or connected to the entertainment unit 100. Accordingly, modulated audio signals travel from the modulator 220 via a wire or wires to the vehicle sound system.

Alternatively, as shown by arrow 237, the user may opt to create a connection to the modulator 230 for receipt of the audio signals to be modulated. Therefore, instead of sending modulated signals via a wired connection to the vehicle sound system, a transmitter 235 included in the modulator 230 wirelessly transmits modulated signals to a vehicle antenna and, in turn to the vehicle sound system connected to the antenna. Like the transmitter 215, the transmitter 235 is also capable of transmitting a modulated signal to a receiver in wireless headphones. In another configuration, in order to achieve wireless transmission of the modulated signals, the connections shown by arrows 227 and 237 are in place, while the connection shown by arrow 221 is eliminated. The presence of the connection shown by arrow 221 can be determined at installation of the entertainment system or controlled by a switch positioned on the control panel 180.

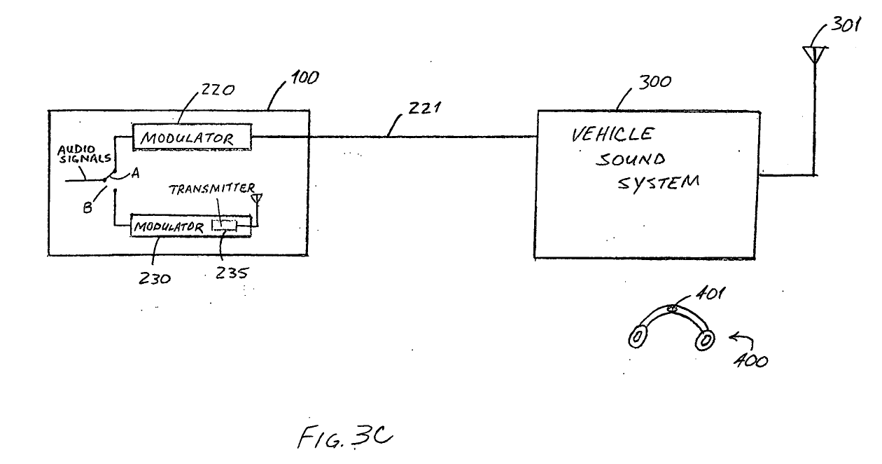

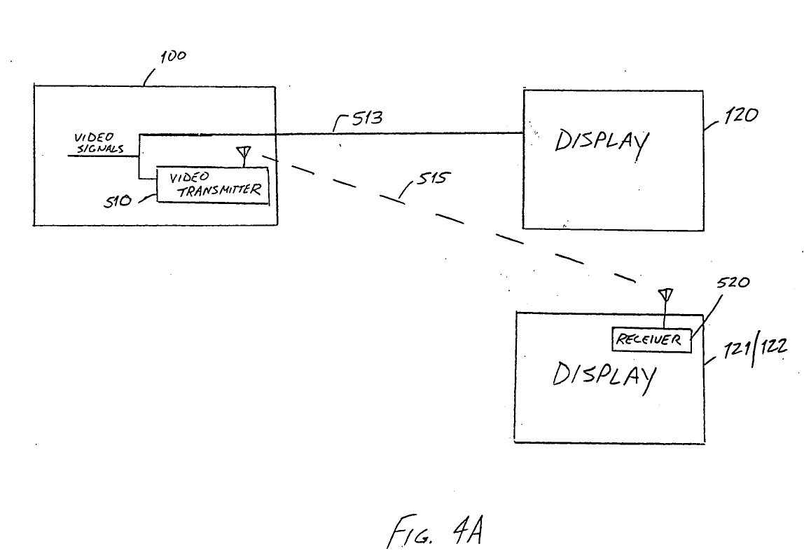

As shown in FIG. 3A, audio signals to be modulated are input to the modulator 220 and a wired connection 221 between the modulator 220 and the vehicle sound system 300 transmits the modulated audio signals to the vehicle sound system 300. As shown in FIG. 3B, audio signals to be modulated are input to the modulator 230 and a transmitter 235 wirelessly transmits the modulated audio signals to an antenna 301 of the vehicle sound system 300 or to a receiver 401 in wireless headphones 400. As shown in FIG. 3B, there is no connection between the modulator 220 and the vehicle sound system 300.

Referring to FIG. 3C, the modulator 220 is wired to the vehicle sound system 300 like the embodiment shown in FIG. 3A. However, in the embodiment shown in FIG. 3C, a user can control whether the audio signals to be modulated are sent to modulator 220 or modulator 230. As shown in FIG. 3C, a switch, which can be positioned on control panel 180, is set to position A to enable input of the audio signals to modulator 220 and position B to enable input of the audio signals to modulator 230. Accordingly, at any time, a user can select between wired and wireless transmission of modulated audio signals to the vehicle sound system 300. Further, by switching to position B, a user can enable wireless transmission of modulated audio signals to wireless headphones 400.

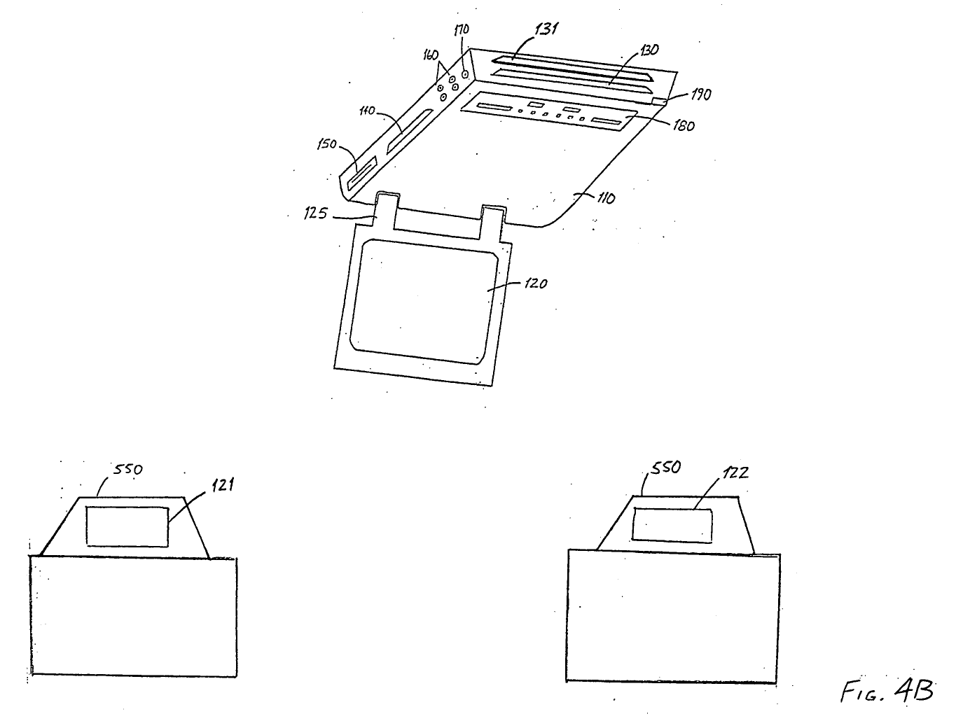

Referring to FIGS. 4A-4B, video signals from a media source connected to or included in the entertainment unit 100, such as an MPEG player, a card reader, a DVD player, a VCD player, a video game player, a videocassette player, and a digital video recorder, are provided to a display 120 via a wired connection path 513 and to displays 121 and 122 via a wireless transmission path 515. As shown in FIG. 4A, the video signals are input to a video transmitter unit 510, including processing components for formatting the video signals for wireless transmission (e.g., wireless radio frequency (RF) transmission) to a receiver 520 located in each display 121 and 122. Formatting may include compression of the video data using, for example, MPEG, MPEG-2 and MPEG-4 procedures. The compressed video data is formatted for RF wireless transmission on an appropriate frequency. The displays 121 and 122 include components, such as demodulators and decoders to reformat the transmitted video data for display. Such reformatting may include decompression of compressed video data. As shown in FIG. 4B, the displays 121 and 122 may be located on the back of a vehicle seat headrest 550. The displays 121 and 122 may be positioned anywhere in the vehicle, such as in the hands of a passenger, on a center console or on the vehicle ceiling. Displays positioned remotely from the entertainment 100 preferably receive video data via wireless transmission. Alternatively, like the display 120, the displays 121 and 122 can be connected to the entertainment unit 100 via a wired connection. Further, any number of displays may be used and the display 120 may be omitted from entertainment unit 100, with video signals still being transmitted to displays positioned remote from the entertainment unit 100.

It is to be understood that in addition to being transmitted via both wired and wireless paths 513 and 515, the path of the video signals may be predetermined at installation so that only the wired or wireless path is used. Further, with a switch located on the control panel 180, a user may select either a wired or wireless connection for transmission of video data.

It is to be understood that more than one media source may be played at one time so that multiple passengers in a vehicle may simultaneously view separate programs on different displays and/or listen to different programs through different audio mechanisms (e.g., through separate headphone sets). Similarly, as shown in FIG. 4B, multiple slots 130, 131 and multiple media players for receiving and playing the same type of media storage medium (e.g., two DVDs) may also be provided such that different programs from the more than one of the same type of media storage medium may be simultaneously played.

The entertainment unit 100 is preferably capable of outputting different programs from multiple media sources, such that displays 120, 121 and 122, wireless headphones 400, and/or vehicle sound systems 300 tuned to an appropriate channel or configured to select a specific program (e.g., through a selection made by an on-screen menu), can receive desired programs through either wired or wireless paths. The entertainment unit 100 may include multiple wired connections and/or multiple wireless transmitters for transmitting audio and video signals corresponding to different programs. For example, audio and video data may be wirelessly transmitted from multiple transmitters via RF or infrared (IR) transmission, where different frequencies from each respective transmitter correspond to different programs. Also, video and audio data from multiple media sources may be wirelessly transmitted from a transmitter in a broadcast stream, and a user may select a program for viewing on a display through, for example, a menu displayed on a screen of the display. In another embodiment, by utilizing a selector button located on the control panel 180, a user may select a desired media source from which video and/or audio data is to be transmitted and received.

Although the illustrative embodiments have been described herein with reference to the accompanying drawings, it is to be understood that the present invention is not limited to those precise embodiments, and that various other changes and modifications may be affected therein by one of ordinary skill in the related art without departing from the scope or spirit of the invention. All such changes and modifications are intended to be included within the scope of the invention as defined by the appended claims.

1. An overhead entertainment system for a vehicle, comprising:
a media player;
a first modulator capable of receiving audio signals for modulation from the media player, wherein the first modulator is connectable to a vehicle sound system via a physical connection for sending modulated audio signals to the vehicle sound system; and
a second modulator capable of receiving the audio signals for modulation from the media player, wherein the second modulator includes a transmitter for wirelessly transmitting the modulated audio signals to a receiver coupled to the vehicle sound system.

2. The overhead entertainment system as recited in claim 1, wherein the media player is one of an MPEG player, a card reader, a DVD player, a CD-ROM player, a video game player, a videocassette player, and a digital video recorder.

3. The overhead entertainment system as recited in claim 1, wherein the first modulator and the second modulator are capable of receiving audio signals for modulation from a media source connected to the entertainment system via at least one port.

4. The overhead entertainment system as recited in claim 3, wherein the at least one port is one of a universal serial bus port, an audio input port, a video input port and an audio/video input port.

5. The overhead entertainment system as recited in claim 1, wherein the entertainment system is capable of receiving and playing at least one of a digital video disc, a compact disc, a video compact disc, a flash card, a secure digital card, a smart media card and a memory stick card.

6. The overhead entertainment system as recited in claim 1, further comprising a switch for switching a path of the audio signals from the media player to the first modulator or to the second modulator.

7. The overhead entertainment system as recited in claim 1, further comprising a switch for opening and closing a connection between the first modulator and the vehicle sound system.

8. The overhead entertainment system as recited in claim 1, wherein a user determines, at the time of installation of the entertainment system into the vehicle, whether the audio signals from the media player are received by the first modulator or the second modulator.

9. The overhead entertainment system as recited in claim 1, wherein a user determines, at the time of installation of the entertainment system into the vehicle, whether to connect the first modulator to the vehicle sound system via the physical connection.

10. The overhead entertainment system as recited in claim 1, wherein the physical connection includes at least one wire.

11. The overhead entertainment system as recited in claim 1, wherein the transmitter wirelessly transmits the modulated audio signals to wireless headphones.

12. The overhead entertainment system as recited in claim 1, wherein the modulated audio signals are wirelessly transmitted on a frequency selected by a user.

13. The overhead entertainment system as recited in claim 1, further comprising a transmitter for wirelessly transmitting video data from the media player to at least one display.

14. An overhead entertainment system for a vehicle, comprising:
a media player; and
a modulator capable of receiving audio signals for modulation from the media player, wherein the modulator is connectable to a vehicle sound system via a physical connection for sending modulated audio signals to the vehicle sound system and connectable to a transmitter for wirelessly transmitting the modulated audio signals to a receiver coupled to the vehicle sound system.

15. The overhead entertainment system as recited in claim 14, wherein the media player is one of an MPEG player, a card reader, a DVD player, a CD-ROM player, a video game player, a videocassette player, and a digital video recorder.

16. The overhead entertainment system as recited in claim 14, wherein the modulator is capable of receiving audio signals for modulation from a media source connected to the entertainment system via at least one port.

17. The overhead entertainment system as recited in claim 16, wherein the at least one port is one of a universal serial bus port, an audio input port, a video input port and an audio/video input port.

18. The overhead entertainment system as recited in claim 14, wherein the entertainment system is capable of receiving and playing at least one of a digital video disc, a compact disc, a video compact disc, a flash card, a secure digital card, a smart media card and a memory stick card.

19. The overhead entertainment system as recited in claim 14, further comprising a switch for opening and closing a connection between the modulator and the transmitter.

20. The overhead entertainment system as recited in claim 14, further comprising a switch for opening and closing a connection between the modulator and the vehicle sound system.

21. The overhead entertainment system as recited in claim 14, wherein a user determines, at the time of installation of the entertainment system into the vehicle, whether to connect the modulator to the transmitter.

22. The overhead entertainment system as recited in claim 14, wherein a user determines, at the time of installation of the entertainment system into the vehicle, whether to connect the modulator to the vehicle sound system via the physical connection.

23. The overhead entertainment system as recited in claim 14, wherein the physical connection includes at least one wire.

24. The overhead entertainment system as recited in claim 14, wherein the transmitter wirelessly transmits the modulated audio signals to wireless headphones.

25. The overhead entertainment system as recited in claim 14, wherein the modulated audio signals are wirelessly transmitted on a frequency selected by a user.

26. The overhead entertainment system as recited in claim 14, further comprising a transmitter for wirelessly transmitting video data from the media player to at least one display.

27. An overhead entertainment system for a vehicle, comprising:
a plurality of media sources outputting at least one of audio data and video data; and
means for modulating the audio data and transferring the modulated audio data to a vehicle sound system, wherein the modulated audio data is capable of being transferred to the vehicle sound system via wired and wireless transmission.

28. The overhead entertainment system as recited in claim 27, wherein the plurality of media sources include any two or more of an MPEG player, a card reader, a DVD player, a CD-ROM player, a video game player, a videocassette player, and a digital video recorder.

29. The overhead entertainment system as recited in claim 27, wherein at least one of the plurality of media sources is connected to the entertainment system via at least one port.

30. The overhead entertainment system as recited in claim 29, wherein the at least one port is one of a universal serial bus port, an audio input port, a video input port and an audio/video input port.

31. The overhead entertainment system as recited in claim 27, wherein the means for modulating and transferring includes a modulator for coupling to the vehicle sound system for wired transmission of the modulated audio data to the vehicle sound system and for coupling to a transmitter for wireless transmission of the modulated audio data to the vehicle sound system.

32. The overhead entertainment system as recited in claim 27, wherein the means for modulating and transferring includes:
a first modulator for coupling to the vehicle sound system for wired transmission of the modulated audio data to the vehicle sound system; and
a second modulator including a transmitter for wireless transmission of the modulated audio data to the vehicle sound system.

33. The overhead entertainment system as recited in claim 27, further comprising means for selecting whether the modulated audio data is transferred to the vehicle sound system via wired or wireless transmission.

34. The overhead entertainment system as recited in claim 27, further comprising means for wirelessly transmitting the video data to at least one display.

35. An overhead entertainment system for a vehicle, comprising:
at least one display;
at least one media source; and
at least one transmitter for wirelessly transmitting video data from the at least one media source to the at least one display.

36. The overhead entertainment system as recited in claim 35, further comprising:
at least one other display; and
a physical connection from the overhead entertainment system to the at least one other displays for transmitting the video data from the at least one media source to the at least one other display.

37. The overhead entertainment system as recited in claim 35, wherein the at least one display is positioned remote from the overhead entertainment system.

38. The overhead entertainment system as recited in claim 35, further comprising at least one other media source, wherein the at least one transmitter simultaneously transmits video data from the at least one other media source and the video data from the at least one media source to the at least one display.

39. The overhead entertainment system as recited in claim 35, further comprising:
at least one other media source; and
at least one other display, wherein the at least one transmitter simultaneously transmits video data from the at least one other media source to the at least one other display and the video data from the at least one media source to the at least one display.

40. The overhead entertainment system as recited in claim 35, further comprising:
at least one other media source; and
at least one other display, wherein the at least one transmitter simultaneously transmits video data from both the at least one media source and the at least one other media source to both the at least one display and the at least one other display.
